(19) United States
(12) Patent Application Publication
(10) Pub. No.: US 2023/0351388 A1
(43) Pub. Date: Nov. 2, 2023

(54) System, Device, and Method of User Authentication and Transaction Verification

(71) Applicant: IRONVEST, INC., New York, NY (US)

(72) Inventors: William Herlands, Cambridge, MA (US); Erez Zohar, Hoboken, NJ (US)

(21) Appl. No.: 18/219,677

(22) Filed: Jul. 9, 2023

Related U.S. Application Data
(63) Continuation of application No. 17/114,579, filed on Dec. 8, 2020.
(60) Provisional application No. 63/369,597, filed on Jul. 27, 2022.
(60) Provisional application No. 62/957,236, filed on Jan. 5, 2020.

(51) Int. Cl. G06F 21/54; G06F 21/64; G06Q 20/40; G06F 21/40

(52) U.S. Cl. CPC G06Q 20/40145; G06F 21/40; G06F 21/54; G06F 21/64

(57) ABSTRACT

Method and system for authenticating identity of a user of an electronic device and for verifying a authenticity of a transaction that the user submits via the electronic device. A method includes: (a) while the user interacts with input units of the electronic device to enter transaction data, capturing video of the user via a front-side camera of the electronic device; (b) while the user interacts with the input units of the electronic device to enter transaction data, generating at the electronic device an interfering device-based event, a particular vibration pattern, a particular illumination pattern, a particular background audio noise pattern, or other interfering event generated by the electronic device; (c) performing a particular analysis of video content, that was captured while the user interacted with input units of the electronic device to enter transaction data; wherein the analysis checks whether or not the captured video content correctly reflects the interfering device-based event.

### CROSS-REFERENCE TO RELATED APPLICATIONS

This patent application is a Continuation of U.S. 17/114,579, filed on Dec. 8, 2020, which is hereby incorporated by reference in its entirety; which claims priority and benefit from U.S. 62/957,236, filed on Jan. 5, 2020, which is hereby incorporated by reference in its entirety.

This patent application also claims priority and benefit from U.S. 63/369,597, filed on Jul. 27, 2022, which is hereby incorporated by reference in its entirety.

### FIELD

The present invention is related to the field of electronic devices and systems.

### BACKGROUND

Millions of people utilize mobile and non-mobile electronic devices, such as smartphones, tablets, laptop computers and desktop computers, in order to perform various activities. Such activities may include, for example, browsing the Internet, sending and receiving electronic mail (email) messages, taking photographs and videos, engaging in a video conference or a chat session, playing games, or the like.

### SUMMARY

The present invention may include devices, systems, and methods of user authentication and/or transaction verification.

For example, a method comprises: (a) monitoring interactions of a user who interacts with an electronic device to enter transaction data, and extracting one or more biometric traits of the user; (b) generating a unified data-item, that represents a unified fusion of both (i) the transaction data, and (ii) biometric data reflecting the one or more biometric traits of the user that were extracted from interactions of the user during entry of transaction data. For example, the transaction data within the unified data-item that is generated in step (b), cannot be modified or corrupted without also causing modification or corruption of the biometric data within the unified data-item; wherein the biometric data within the unified data-item that is generated in step (b), cannot be modified or corrupted without also causing modification or corruption of the transaction data within the unified data-item. Modification or corruption of the transaction data within the unified data-item, automatically causes modification or corruption of the biometric data within the unified data-item; and modification or corruption of the biometric data within the unified data-item, automatically causes modification or corruption of the biometric data within the unified data-item.

The present invention may provide other and/or additional benefits or advantages.

### BRIEF DESCRIPTION OF THE DRAWINGS

FIG. 1 is a schematic block-diagram illustration of a system, in accordance with some demonstrative embodiments of the present invention.

### DETAILED DESCRIPTION OF SOME DEMONSTRATIVE EMBODIMENTS OF THE PRESENT INVENTION

The present invention provides novel cybersecurity identity authorization and fraud detection methods, as well as systems and devices for implementing or executing such methods. For example, the method of the present invention fuses or combines or aggregates biometric data and transaction information into a single data channel or a single data stream or a single data vector, in order to simultaneously (I) encode (or digitally represent, particularly using cryptographic methods such as encryption) the user identity and (II) validate the user’s transaction information. The system and method of the present invention may be utilized in any suitable transaction context, such as, for example: transferring money or wiring funds to another person or entity in a banking application or “app” or website or web-based interface; transferring a cryptocurrency or paying via cryptocurrency; performing a wire transfer or an electronic funds transfer; performing an online purchase transaction or an electronic commerce (e-commerce) transaction at an online retailer or an online vendor; performing other type of online banking transaction or online brokerage transaction; performing other types of financial transactions or commercial transactions; or the like.

A demonstrative system in according to the present invention may include the following parties: (a) User who transacts; (b) Digital application on which the transaction UI or GUI exists or is displayed or is otherwise communication (e.g., a web application, a website, a web-page, a web-friendly application, a stand-alone or native application or “app”, a downloadable application, an application that runs within a web browser); and (c) an external (e.g., remote) server for secure processing.

In some embodiments, in addition to directly authenticating users and transactions, the system may pose a requirement for the user (who attempts to initiate a transaction) to be recorded (e.g., to have his video and/or audio be recorded or captured or acquired); and this requirement by itself may dissuade or prevent at least some malicious users or attackers from performing a fraudulent transaction, as they do not want to provide their true identities and do not wish to have their image or audio recorded or captured or acquired; and this by itself may reduce fraud, and/or may homogenize attack vectors.

The Applicants have realized that at the core of a typical digital transactional system lies a fundamental separation between (I) “authentication” of a user, and (II) “verification” of a particular transaction that the user performs. For example, realized the Applicants, in a conventional banking website or application, a user is authenticated with their username and password; and then, at a later time-point and as a separate step, their particular transaction is verified. The Applicants have realized that this gap between authentication and verification may often be exploited by attackers, yet conventional cybersecurity systems continue to accept this axiomatic distinction and this gap. For example, realized the Applicants, stronger password protection only concentrates on user authentication, whereas advanced encryption of data only concentrates on transaction verification. The Applicants have realized that even advanced AI-based cybersecurity systems accept this distinction and this gap.

The system and method of the present invention unify authentication and verification into a single paradigm or into a single unified process or step or into a gap-less process. Specifically, the system of the present invention authenticates the user through biometrics, and then decodes the transaction from the biometric representation itself. Therefore, in accordance with embodiments of the present invention, it would be virtually impossible to forge or to fake a user’s identity without also corrupting the transaction itself at the same time, and it would be virtually impossible to manipulate the digital representation of the transaction without simultaneously nullifying or affecting the biometric data that represents and authenticates the user’s identity. The present invention thus provides a significantly more robust version of security and cybersecurity.

In some embodiments, the system and method of the present invention create a unified channel or a unified stream of data, which combines or fuses or encodes therein: digital data entered by the user (e.g., monetary amount to be transferred; recipient or beneficiary name and account number), and digital video data captured by the camera of the end-user device (e.g., one or more selected frames from a video that is recorded while the user is performing the transaction). Optionally, the video data reflects real-life or physical or “analog” events or phenomena that may have occurred during the recording of the video, which may be used for transaction verification purposes.

In some embodiments, optionally, the data that is encode into one or more video frame(s) may include one or more digital data-items that relate to the transaction being entered and/or submitted, including (but not limited to) data representing or indicating one or more digital background events that cause or that yield the transaction details; for example, in addition to encoding digital data representing “$625” as a wire transfer amount, the encoded data may further include a representation of one or more underlying JavaScript events that were triggered by keypresses of the user entering such data, or data indicating on-screen gestures and on-screen interactions of the user typing or entering such data via a touch-screen, and/or other digital background events or digital underlying events which the system may sense and collect and may then selectively encode into one or more video frame(s), as described herein.

In some embodiments, the transaction data is encoded into one or more of the video frames. In some embodiments, the system injects or generates or creates one or more real-world phenomena or events that cause, directly or indirectly, an effect on the video being recorded, and the system then verifies (e.g., at a remote server, and/or in the end-user device) that the recorded video indeed reflects such injected phenomena or such inserted events. For example, the end-user device may vibrate in accordance with a particular pattern while the video is being recorded or captured; and the captured video may then be analyzed to verify that its content indeed reflects that pattern of vibrations; accordingly, an “analog” or real-world event, or its real-life effect or result or interference or interfering event, is injected or added or inserted indirectly into the digital video recording or is augmenting the content of the video recording, in order to assist in verification and/or authentication. Similarly, the end-user device may generate one or more audio sounds or particular beeps or particular noises, or may emit pre-defined sounds or utterances, while the video and audio are being recorded; and the captured video and audio may then be analyzed to verify that their content indeed reflects the generated audio.

In another example, the end-user device may be configured by the system to generate selectively-modulated illumination or illumination-patterns or illumination-bursts, via a “flash” illumination unit of the end-user device (e.g., particularly a tablet or a smartphone equipped with a camera coupled to an illumination unit), or to otherwise cause on-screen projection or in-screen projection of one or more illumination patterns or colors; and concurrently, a video is being captured by a camera of the end-user device, and the captured video may then be analyzed to determine whether its content indeed shows an illumination pattern or an illumination signature that matches the illuminated pattern that is known to the system. For example, an illumination unit or a “flash” illumination unit of the end-user device, may be commanded to illuminate in accordance with a pre-defined illumination pattern, such as, “1-0-1-1-0-1-0-0-1-1-1”, wherein “0” indicates non-illumination for one second, and wherein “1” indicates illumination for one second; and the content of the captured video may be analyzed to determine whether it reflects such precise changes in illumination, in accordance with such timing and sequence. In another example, the screen of the end-user device may be configured by the system to change its background color, or to have a flashing border or margin, in accordance with such pattern; and the content of the captured video may be analyzed to determine whether it reflects such precise changes in illumination, in accordance with such timing and sequence.

Some embodiments of the present invention may thus operate to detect or prevent or eliminate or mitigate fraudulent transactions or fraud attempts, that are performed or attempted by a human attacker or impostor, or by an automated malware or trojan or malicious program or malicious script. Some embodiments may generate an alert notification or a warning message upon such detection of fraud or possible fraud; and may send or transmit such notification to a human auditor, to a fraud handling department, to a cyber-security team, to a system administrator, to an automated malware protection unit or malware removal unit, or to other entities. Some embodiments may automatically trigger or perform, automatically and/or autonomously, one or more fraud mitigation operations upon such detection; for example, by placing a hold or a freeze or a blocking command on a transaction or an account, or by requiring the user to perform re-authentication or multiple-factor authentication, or by requiring the user to re-try the transaction or to re-enter one or more of the transaction details, or by requiring the user to contact a customer service representative by phone or in person, or the like.

The following is a demonstrative method, in accordance with some embodiments of the present invention.

In a first step of the method, a biometric representation of the user is created and stored. This may be achieved through active or passive registration.

For example, the biometric representation of a user may be created or generated actively via an Active Registration Unit, by recording audio and/or video of the user or a single image or the user or a set of several images of the user (e.g., via a camera and/or a microphone) and optionally, in some implementations, also requesting that the user performs a pre-defined behavioral gesture or task (e.g., in some implementations, requiring the user to move his face in a particular pattern) to facilitate the information that is required for establishing a full biometric representation. In some embodiments, this implementation may require that the user would have been validated previously as the true (genuine, legitimate) user, such as via a password or via two-factor or multi-factor authentication, to ensure that the biometric representation is correct.

Alternatively, in some implementations, the biometric representation of the user may be created or generated passively, via a Passive Registration Unit, in a manner that is transparent to the user, by recording the user interacting with the interface (e.g., as discussed below) during one or more usage sessions. Optionally, these usage sessions can then be validated through a third party or by an external mechanism, and the recordings can be used to passively create a biometric representation of the user. As an example of such external validation, the transaction may be a wire transfer of User Adam; the banking system may detect that User Adam routinely performs a wire transfer of $2,400 on the first day of every calendar month towards User Bob; the banking system detects that after several such regular or repeated transfers, there are no complaints or allegations of fraud or other objections from User Adam (e.g., in response to emails and text messages that notify User Adam that an outgoing wire transfer was commanded in his bank account); and thus, the banking system is confident that these wire transfers are valid and legitimate and are non-fraudulent. Accordingly, the system of the present invention may be configured to passively “watch” or monitor several such transactions of User Adam, and to wait for an indication from the banking system that these transactions are legitimate and non-fraudulent; and a user profile for User Adam may then be constructed, retroactively, based on the behavior of the user as recorded and/or monitored during those legitimate transactions.

In some embodiments, once the biometric representation has been created or generated, via passive user registration or by active user registration or by a hybrid process of active and passive user registration, the raw images and video need not be stored, or may be deleted or discarded, thereby ensuring or increasing privacy for the user.

In a second step of the method, when the user opens or launches or accesses the application or website or web-page in order to perform or submit a transaction of any kind, a webcam or camera or imager (and optionally also a microphone) on the user’s electronic device (e.g., smartphone, tablet, laptop computer) is enabled or activated or turned on, and automatically begins recording and capturing the field-of-view, thereby recording or capturing a video (and optionally also audio; or, in some embodiments, by capturing one or more images of the user at particular time-points that are defined as important and relevant from the point of view of authenticating the user and verifying the transaction) of the user’s face and/or facial expression and/or head and/or behavior and/or gestures and/or pose and other user-related images or video or sound; in some implementations, capturing of a video, or of one or more images, of the user’s face or face-area or head or head-area (e.g., from the shoulders up, or from the neck up, or from the chin up) may suffice. In some embodiments, this ongoing video recording may be shown in real-time to the user on the screen of his electronic device, along with (or within) the application itself. For example, this video that is being recorded or captured, may be shown to the user in the background of the application, with the application material overlaying; or it may be shown as a separate element or component on the screen; or as an internal window or tab; or as a picture-in-picture playback; or using other suitable on-screen location and styling methods. In some embodiments, the video continues recording and the video (and/or audio) continue to be captured by the electronic device, until the user completes a pre-specified or pre-defined action or set of operations, such as, until the user finalizes a set of actions for commanding to send out a transfer of funds, or until the user finished clicking or tapping on a final “submit transaction” button or link or GUI element. In some embodiments, the recording or acquisition of video and/or audio may optionally continue for a short period of time (e.g., 1 or 2 or 3 more seconds) beyond the final act performed by the end-user; in order to capture a small amount of post-transaction or post-submission events, as it may sometimes take the end-user device a short period of time to completely stop an intervening event or an injected event or a fixed action pattern that was initiated during the transaction submission process; for example, a five-seconds Vibration Pattern that was introduced into the transaction submission process, may terminate slightly after the quick user has already tapped his “submit transaction” button or link, and thus some implementations may optionally capture or record a few additional seconds of video and/or audio even after the transaction was submitted.

In a third step of the method, when the user opens or launches or accesses the application or website, an external (remote) server sends to the user’s electronic device a unique digital key or digital token or other digital data-item or digital verification item for that transaction. Optionally, through a random or pseudo-random process, this unique digital key, combined with timestamps and other information about the electronic device and the application (e.g., the MAC address of the electronic device; its current Internet Protocol (IP) address; an exact version and build number of the Operating System and/or of the relevant application; the local time as reported by the electronic device; the time zone as reported by the electronic device; or the like), may then be utilized to uniquely determine the random processes and encodings used throughout this technique. For example, a first end-user device of User Adam, who attempts to performs a wire transfer operation via his iPhone, may be assigned or allocated a first process for unified user authentication and transaction verification; whereas, a second end-user device of User Bob, who attempts to perform a wire transfer operation via his Samsung Galaxy smartphone, may be assigned or allocated a second, different, process for unified user authentication and transaction verification; each process being determined in a selection process or in a construction process that takes into account, for example the unique digital key of each session or transaction, and other user-specific or device-specific parameters or characteristics.

In step four of the method, one or more images or frames of the captured video are encoded with (or augmented with) information about the user’s interaction with the application or with the end-user device. These can be encoded in one or more ways, as discussed above and/or herein. Images or frames from the video are sent, periodically or from time to time, or continuously or substantially continuously, to the external (remote) server for processing.

In step five of the method, when requested by the application, the external (remote) server performs the following: (a) It authenticates the user’s identity, by matching the biometric profile to the images or frames from the application-recorded video; and also, substantially simultaneously, (b) it validates or verifies the transaction details by decoding the information that was encoded into the recorded images or frames; and also, substantially simultaneously, (c) it verifies the liveliness of the user and/or the freshness of the transaction (e.g., protecting from a replay attack; or protecting from a spoofing attack, in which an attacker utilizes an image or a mask or a deep-fake image or a deep-fake video of the legitimate user). The authentication information is then securely returned or sent to or transferred to the application and/or to the relevant application server (e.g., in an implementation where Server 1 performs or handles the authentication and verification, and Server 2 performs or handles the actual transaction) and/or to the relevant server that is responsible with actually performing the user-submitted transaction (e.g., the banking server of the bank, or a cloud-computing server of the bank which runs the server-side banking application).

In some embodiments, for users who do not yet have a biometric profile created for them, the system may still provide authentication, as described further herein in relation to “First Time Users”.

In accordance with some embodiments, the processing power, the bandwidth, and/or the memory resources (or other resources) of the electronic device of the end-user, which may be required for locally executing the application and for performing the client-side operations, may be independent of the length of the session or of the type of the transaction. For example, instead of capturing-and-sending, or streaming, an entire video of the session (or, a video of a segment or a time-slot of the session) to an external remote server, the system instead may operate to selectively capture image snapshot(s) or screen grabs or selected frames at discrete moments in time or at pre-defined time intervals or time-points (e.g., every second) or at pseudo-random time intervals or time-points (e.g., at time intervals that are selected randomly from the range of 0.5 seconds to 0.9 seconds), or at particular time-points during the transaction or during the transaction entry process or during the transaction submission process that are defined or pre-defined as “strategic” or as “important and relevant” from the point-of-view of authenticating the user and/or verifying the transaction (e.g., as non-limiting examples, at a time-point in which the user types in a beneficiary name for a wire transfer; at a time-point in which the user enters a bank account number of a recipient of a wire transfer; wherein each type of transaction may be associated with a pre-defined set of such time-points that are defined as strategic or important for this type of transaction); and then sends to the remote server only those images or frames, or even their partial and/or encoded representation. The events triggering these snapshots, or the conditions that cause the selective grabbing or capturing or isolating of particular video frames for transmission to the remote server, may vary from session to session or from user to user or from device to device (e.g., may vary across two different usage sessions of the same user, such as on two different days), or may vary from application to application (e.g., may vary from the application used by Bank A, to the application used by Bank B). In some embodiments, they may typically include video frames or video segments or video portions that correspond, at least, to any time-window in which the user has actively interacted with his electronic device, and/or any time in which the user types on the device or taps or clicks or scrolls the screen, and/or any time in which the user interacted via touch gestures with a touch-screen of the electronic device, and/or any time in which the user interacted with one or more GUI elements or with a touch-pad or touch-screen or mouse or keyboard or on-screen keyboard, and/or any time in which the user entered data into the application (e.g., entered or typed or pasted any username or password or other credentials, or monetary amount, or beneficiary details), and/or any time that the application itself was closed or started or launched or otherwise interacted with, and/or one or more routine images or video frames that are captured and sent on a regular basis, such as, at pre-defined time intervals (e.g., once per two seconds), or at random or semi-random time intervals (e.g., at a random time interval that changes randomly in the range of 4 to 6 seconds). In some embodiments, a video is captured and stored locally on the end-user device during the entry of the data of the transaction by the user; and then, optionally, the video is encoded or re-encoded or augmented to further encode therein one or more transaction-related data; and then, the captured video is uploaded or is transmitted from the end-user device to the remote server, which in turn processes the video and analyzes its content to determine whether the content reflects one or more modulations or events that were introduced to (or by, or at) the end-user device during the capturing of the video. In other embodiments, a live video feed is acquired and uploaded in real time, as a live streaming video, from the end-user device to the remote server, during the data-entry of the transaction; and the remote server analyzes the content of the streamed video feed to determine whether it reflects one or more modulations or events that were introduced to (or by, or at) the end-user device during the capturing of the video. In other embodiments, the video may be streamed or uploaded in real time from the end-user device to the remote server, and also, the video may be captured locally or saved locally from the end-user device to the remote server after the transaction has already be submitted; and both the real-time streamed video, and the recorded and uploaded video, may be analyzed at the remote server, for double confirmation or dual confirmation; and this mechanism may be useful, for example, in a situation where the end-user device has a low-bandwidth Internet connection during the submission of the transaction, which may or may not suffice for streaming high-quality video to the remote server in real time, and thus the post-transaction video uploading may be uploaded (e.g., a few seconds or minutes or even hours) after the transaction was submitted, for further processing; and optionally, the transaction processing server may put a temporary “hold” or “freeze” on the submitted transaction until it receives the uploaded video and processes it. In other embodiments, the streaming of real-time video and/or the uploading of recorded video, may be implemented as streaming and/or uploading of one or more selected frames or images, and/or as streaming and/or uploading of one or more selected video-segments or time-slots, and/or as streaming and/or uploading of one or more selected audio portions. In some embodiments, the processing of the video may be performed exclusively at the remote server; or, may be performed exclusively locally at the end-user device; or, may be performed partially at the remote server and partially at the end-user device; or, may be performed in parallel by both the remote server and the end-user device. Other suitable mechanisms may be used.

Some embodiments may utilize one or more suitable means of combining or fusing or merging together: (i) the user generated input (e.g., the transaction data that the user entered via his electronic device), and (ii) the user biometric information (e.g., as captured by the camera and/or microphone of the electronic device and/or by other sensors of the electronic device), into a single unified channel or a single or unified data-item or datagram or message or data-stream or information vector, which represents concurrently both of those items. In some embodiments, the system may be agnostic to the means by which the user information and/or biometrics are integrated into the unified representation; and/or the system may simultaneously use two or more of such techniques, for example, in order to increase security and/or reliability. As mentioned above, the single unified channel that is generated and utilized by the system may include, optionally, one or more digital data-items that relate to the transaction being entered and/or submitted, including (but not limited to) data representing or indicating one or more digital background events that cause or that yield the transaction details; for example, in addition to encoding digital data representing “$625” as a wire transfer amount, the encoded data may further include a representation of one or more underlying JavaScript events that were triggered by keypresses of the user entering such data, or data indicating on-screen gestures and on-screen interactions of the user typing or entering such data via a touch-screen, and/or other digital background events or digital underlying events which the system may sense and collect and may then selectively encode into one or more video frame(s), as described. Some of the techniques which may be used, may be device specific and/or application specific, and/or may depend on the particular electronic device being used and/or on the particular application or implementation.

In some embodiments, optionally, the system may perform encoding of every keystroke that a user performs (or, every Nth keystroke), into one or more corresponding (or non-corresponding) frames of the video that is captured; such as, via secure watermarks, or by hidden watermarks, or by embedding suitable watermark(s) into selected video frame(s) and/or into all or most of the video frame(s) that are captured and/or that are transmitted to the remote server. Some embodiments may utilize steganography techniques in order to store and conceal data (e.g., keystrokes, device-specific data, user-specific data) into images or frames or video or audio. In some embodiments, when user Adam enters his name “Adam” through a physical keyboard or an on-screen keyboard, a digital encoding or representation of the letter “A” is added to Frame Number P of a video being captured while he types; then, a digital encoding or representation of “d” is added to Frame Number P+4 of the video being captured while he types; and so forth, thereby encoding a digital representation of each keystroke into a separate frame of the captured video. In some embodiments, Use Adam may type the letter “A” when the camera is capturing Frame number F, and the actual encoding of the representation of the letter “A” may be performed into a subsequent frame, such as Frame number F+3, as it may take a slight time period to generate the encoded data and/or to add it. In some embodiments, “keystrokes” may include incorrect data or typographical errors typed by the user; such as, adding a digital encoding or representation of a “backspace” or a “delete” keystroke or a CTRL or Shift key-press, or the like. Later, a remote server may reject the transaction or block it, based on the existence or based on the lacking of a particular keystroke, from the data encoded into frame(s) of the video; and/or based on the timing of such data. For example, a transaction may be blocked or rejected if the data submitted by the transaction form indicates that the user name is “Janet”, while the keystroke data that was encoded into the relevant particular frames of the video indicates that the submitting user has actually typed the letters for “Emily” (five characters, but different characters) or for “Jane” (different number of characters, even though the first four characters are the same).

In some embodiments, optionally, for touch sensitive screens or touch-screens, encoding the spatial or geographical location of the electronic device of the user (e.g., obtained via GPS, or via Wi-Fi based location detection, or via other suitable location finding techniques, or based on data sensed by spatial orientation sensor(s) of the device), and/or the size or other properties of the interaction of the user with the electronic device (e.g., the size of the fingerprint of the user on the touch-screen in a particular interaction), and/or the time duration or time-length of each time the user interacts with the touch screen (e.g., presses, types on, swipes, clicks, taps, scrolls, or the like); wherein such information is inserted or injected or encoded into one or more frames of the video that is or was captured. For example, User Bob clicks on a drop-down menu of “select payee” via his touch-screen; the electronic device senses that (i) the size of the fingerprint is approximately a circle having a diameter of 84 on-screen pixels, and that (ii) the touch duration for this on-screen touch operation was 0.70 seconds; and these two items of information, such as D=84 and T=0.70, may be encoded or digitally added into one frame or into several frames of the video that was captured during the transaction entry process.

In some embodiments, optionally, for end-user devices having one or more accelerometers, such as some smartphones or tablets or smart-watches, the system may perform and utilize encoding the accelerometer data (e.g., the data sensed or measured by the accelerometer(s) of the electronic device) into one or more frames of the video captured during the data entry process. In some embodiments, only selected or some images or frames from the video are sent (e.g., every so often, or at pre-defined time-intervals, or at random time-intervals, or when one or more conditions hold true). In some embodiments, the end-user device may optionally aggregate and then encode in a video frame (or in some video frames) some or all of the accelerometer data that occurred or that was sensed or measured, from the last video frame that was actually sent to the remote server, until the current frame that is about to be sent to the remote server, into the current frame that is about to be sent to the remote server; such that the currently-sent frame may include, encoded therein, a digital representation of accelerometer data that spans a time-period of several seconds, in some situations.

In some embodiments, optionally, based on a random digital key or based on other random or pseudo-random parameter or criteria, the system may utilize and/or encode, for example, a match (or a mismatch) between: (i) one or more selected user inputs (e.g., specific numbers or digits or characters that the user types), and (ii) one or more direct modulations of the camera of the electronic device, such as, changing the zoom (zoom in, zoom out), changing the lens focus, rotating the screen (or rotating the entirety of the electronic device), flashing the camera (e.g., causing the camera to light its flash or to activate its illumination unit) on and off (e.g., optionally in accordance with a particular pre-defined pattern), or the like. These changes and/or similar modifications may be initiated by the end-user device, and may be sustained (e.g., for several seconds) or may be temporary (e.g., may be performed one single time during the user interaction; or may be performed a particular number of times during the user interactions). These changes are encoded in the camera recording, and therefore they can be used by the system of the present invention to decode the original inputs that were actually made by the user. In a demonstrative example, user Carl is entering data into his smartphone to command a wire transfer; the process takes him 60 seconds; during this data entry process, a video is captured by the smartphone, at a frame capture rate of 30 FPS; at the 17th second of the process, the application causes the smartphone to activate its “flash” (its illumination unit) for exactly 1.5 seconds; this causes, or should cause, a set of 45 frames (or approximately 45 frames) to appear brighter or much brighter relative to the other frames, due to the illumination effect that was injected during the data entry process. The remote server may then verify or check, whether the particular frames of the video (or some of them) indeed reflect such injected event of added illumination, as a condition for approving or rejecting the submitted transaction.

In some embodiments, optionally, based on a random digital key or other random or pseudo-random parameter or criteria, some embodiments may utilize a match (or a mismatch) between: (i) one or more selected user inputs (e.g., specific numbers or digits or characters that the user types), and (ii) one or more indirect modulations of the camera of the end-user device; such as, vibrating or causing a vibration of the phone (or other end-user device that is utilized by the user), optionally in accordance with a particular vibration pattern, such that the recorded image or the recorded video is vibrated as well or reflects such induced spatial vibration. These changes are encoded in the camera recording, and therefore they can be used to decode the original inputs by the user. In a demonstrative example, user David is entering data into his smartphone to command a wire transfer; the process takes him 40 seconds; during this data entry process, a video is captured by the smartphone, at a frame capture rate of 30 FPS; at the 24th second of the process, the application causes the smartphone to activate its vibration unit for exactly two seconds; this causes, or should cause, a set of 60 frames (or approximately 60 frames) to appear fuzzy or out-of-focus, or to visibly show a displacement of objects or a displacement of the field-of-view by at least a few pixels (e.g., a head-shot of the user should be shown at a slight displacement of a few pixels to the right, then to the left, then to the right, and so forth,, due to the vibration of the device and its camera). The remote server may then verify or check, whether the particular frames of the video (or some of them) indeed reflect such injected event of added vibrations, as a condition for approving or rejecting the submitted transaction.

In some embodiments, optionally, based on a random digital key or other random or pseudo-random parameter or criteria, the system may utilize a match (or a mismatch) between: (i) one or more selected user inputs (e.g., specific numbers or digits or characters that the user types), and (ii) the audio playing of one or more specific sounds or audio-clips or audible output or beeps or noises or other audio output from the speaker(s) of the electronic device of the user. The sound and video recordings can then be cross-referenced to ensure validity. In a demonstrative example, user Albert is entering data into his smartphone to command a wire transfer; the process takes him 45 seconds; during this data entry process, an audio-and-video clip is captured by the smartphone; at the 26th second of the process, the application causes the smartphone to generate a particular sound (e.g., a pre-recorded sound, a beep, an utterance a particular word or phrase, or the like) having a particular time-length (e.g., one second); this causes, or should cause, a one-second segment of the captured audio to include the pre-defined audio that was generated. The remote server may then verify or check, whether the particular portions of the captured audio (or, of the captured video-and-audio) indeed reflect such injected event of added background audio, as a condition for approving or rejecting the submitted transaction.

In some embodiments, optionally, the end-user device may be configured by the system to actively present to the user one or more requirements or challenges, such as, a requirement a to speak or to utter or to say specific part(s) of the transaction details while also recording a video of the user. This speech or audio stream is recorded by the end-user device. The sound and video recordings can then be cross referenced to ensure validity. In a demonstrative example, user Richard is entering data into his smartphone to command a wire transfer; the process takes him 50 seconds; during this data entry process, an audio-and-video clip is captured by the smartphone; at the 27th second of the process, the application causes the smartphone to display an on-screen message of “Please say now the word Passport”, and/or to playback an audio clip that says “Please say now the word Passport”; wherein the particular word (“Passport”) is selected randomly from a pool of pre-defined words or phrases; this on-screen message or audio message should cause user Richard to say the word “Passport” in the next few seconds that followed that message. The remote server may then verify or check, whether the particular portions of the captured audio (or, of the captured video-and-audio) indeed reflect such word(s) spoken by the user (optionally, utilizing a speech-to-text converter or an Automatic Speech Recognition (ASR) unit to convert the captured audio into a string of characters or into word(s) for matching purposes), as a condition for approving or rejecting the submitted transaction

In some embodiments, optionally, the end-user device may record its own audio speaker(s) while they are playing specific parts of the user input details (e.g., the amount of money that the user requests to transfer), while also recording a video of the user. The speaker sounds or the audio output, optionally, can be uniquely modulated or modified or distorted in a particular manner, configured or programmed by the application or by the system, for each application or implementation, or even for each application session or usage-session or log-in session or transaction; for example, causing the end-user device to distort the audio playback in one manner for transaction 1 of user Adam; then, after one hour, distort the audio playback in a different manner for transaction 2 of user Adam, or for another transaction of user Bob). The sound and video recordings can then be cross-referenced to ensure validity. For example, the existence or the lack of a matching audio distortion in the captured audio (or, in the captured video-and-audio) may be used by the remote server to approve or reject the submitted transaction.

In some embodiments, optionally, the end-user device may present the application details or data or text or images or other content on the screen of the end-user device, in a unique way or in a modified way, and the camera of the end-user device may record a video of the user as he reads the content and/or interacts with it; and this may be used for transaction verification, or for rejecting or approving a submitted transaction. For example, user Carl is utilizing his tablet to enter data for a wire transfer, in a process that takes him 50 seconds; a video is being captured during this process via the front-side camera of the tablet; during this process, at the 18th second of the process, a content item (e.g., a text portion, or a GUI element) on the screen of the tablet is actively moved or displaced by the application, from the top part of the screen to the bottom of the screen and then again to the top of the screen, in an on-screen movement scheme that takes (for example) three seconds; one or more eye tracking techniques or image analysis or video analysis or computer vision techniques may be used (e.g., optionally utilizing Machine Learning (ML), or other suitable computer vision method) in order to follow and track the eyes of the user in the video recording, and to thereby verify that the user is directly engaging with the displayed material; for example, by detecting that the video captured by the end-user device, indeed depicts the face of a user in which the eyes of the user are shown gazing upwardly and then moving the gaze downwardly and then moving the gaze upwardly, in said example). For example, if the captured video does not show a change in the gazing direction of the user, or in the spatial face positioning of the user, from the 18th second of the video until the 21st second of the video, then the remote server may reject or block the transaction, since the captured video does not reflect the expected change(s) in its content that should have been triggered by the on-screen movement of the content-item or the GUI element during that time-period within the data entry process.

In some embodiments, optionally, the end-user device may present a physical challenge to the user, which may then be utilized for authentication or verification purposes; for example, requesting the user to raise his hand, or to make a V symbol with his fingers, or to do a “thumb up” or a “thumb down” gesture with his fingers. Such physical challenges or physical requirements or tasks may be triggered or initiated based on specific inputs of the user, or may be initiated randomly or pseudo-randomly, or if a particular type of transaction or transaction-data is entered (e.g., only for wire transfers, or only for wire transfers greater than 500 dollars to a new recipient). The manner in which the user performs the physical challenge is recorded by the camera of the end-user device which is recording the video of the user; and computer vision or image recognition methods may then be applied to the recorded video, to authenticate that the transaction was indeed authorized by the user, and/or to ensure liveness, and/or to block or detect a replay attack, or for other security-related purposes.

Some embodiments may optionally utilize augmented reality (AR) to generate and/or to present one or more virtual challenges or AR-based challenges to the user, which are then utilized for authentication or verification purposes. For example, the end-user device may require the user to touch a specific point in space; and such AR-based requirement or task may be triggered or initiated based on specific inputs of the user, or may be initiated randomly or pseudo-randomly, or if a particular type of transaction or transaction-data is entered. The manner in which the user performs the requested challenge is recorded by the camera (and/or by other sensors) of the end-user device, and image recognition or computer vision may then be applied to the video recording to authenticate that the transaction was indeed authorized by the user. In some embodiments, the AR-based task or challenge may be implemented using a dedicated AR-based device or unit (e.g., an AR-based helmet or glasses or head-gear or wearable device or other gear); however, in other embodiments, the AR-based task or challenge need not use any such additional or dedicated device, but rather, may be presented to the user via his regular end-user device (e.g., laptop computer, desktop computer, smartphone, tablet), such as by providing textual instructions and/or graphical instructions and/or audible instructions with regard to the required AR-based task, and then capturing and/or streaming video (e.g., recorded video that is captured locally and then uploaded, or a live video feed that is uploaded as a real-time streaming video) via the camera of the end-user device, as such camera can capture video which is then analyzed to determine whether it reflects user gestures that correspond to the AR-based task or challenge that was required from the user to perform.

Some embodiments may optionally use augmented reality (AR) to present the user with a means of inputting information to the application, through an augmented reality (AR) interface of other AR-based elements or components. For example, some embodiments may generate or present an AR-based keyboard or keypad or other AR-based input mechanism, which may be displayed in space and may allow the user to “type” or to tap virtually on such AR-based keyboard or input-unit, by performing spatial gestures in mid-air or on a planar object (e.g., a table), in order to enter information into the application. The challenge is recorded by the camera of the end-user device, and the video recording can then be used to authenticate that the transaction was indeed authorized by the user.

Some embodiments may operate to detect when a face (e.g., a human face) is present in the video frame that was captured by the camera of the end-user device, using image recognition or computer vision techniques. For example, if the face (e.g., any human face; or a particular human face of a particular human user) is not present (e.g., is not detected, or is not recognized) in one or more video frame(s) for a pre-defined period of time (e.g., for at least N seconds), then the end-user device may generate or provide to the user a warning (e.g., text-based warning, visual warning, audible warning) that the user should place his face within the field-of-view of the video that is being captured. This may enable the system to ensure that biometric information is available throughout the recorded session. In some embodiments, a lack of detection of a human face, for a pre-defined number of captured video frames (e.g., in at least M out of the N frames that were captured during the data entry process), and/or for a particular time-length (e.g., for at least T1 consecutive seconds; or for at least T2 non-consecutive seconds in the aggregate), may trigger the system to reject or block a submitted transaction.

In some embodiments, liveliness and/or freshness may be ensured or verified through one or more techniques that may be employed separately or in consort or in the aggregate. These techniques may include, for example, the following or other suitable methods.

In a first example for ensuring liveness and freshness, the end-user device may be configured to generate and display a box or a window or an on-screen content-item, inside or within the video frame, that moves around in accordance with a pattern defined by a random digital key or in accordance with a pre-defined movement pattern (e.g., which may optionally be selected randomly from a pool of multiple such pre-defined movement patterns). The user is thus required to keep his face inside the on-screen frame for a particular (e.g., substantial) period of time of the session or for at least a certain percentage of the session. This ensures that the user is actively engaged with the end-user device and with the application screen. Optionally, computer vision techniques or image recognition techniques may be used to ensure that the user’s face indeed appears in the relevant video frame(s) that were captured, and/or that the eye gaze of the user is directed towards a relevant direction based on the movement that occurs to particular content item(s) on the screen; and such detected matches or mismatches may be used by the system to reject or approve a transaction.

In a second example for ensuring liveness and freshness, some embodiments may perform post-processing or real-time processing for screen detection, to ensure that a malicious actor or an attacker did not try to spoof the user’s identify by maliciously utilizing a digital image or a digital video of the legitimate user that the attacker is playing or displaying on a computer screen or an a screen of other electronic device of the attacker. For example, a transaction is entered via a smartphone that is alleged to be the smartphone of user Adam that is operated by user Adam; the application requires the user to look into the front-side camera; a preliminary computer vision analysis of the video that was captured, shows that indeed there is a human face present in the captured video; a secondary analysis shows that the human face is indeed a match to a pre-stored image of the legitimate user (Adam), and that it appears to be live (e.g., the captured video shows a moving face of a human); however, a further computer vision analysis of the captured video, may reveal that the captured video also shows a thin black frame of an iPad or other tablet, surrounding the human face, thereby enabling the system to determine that this is actually an attacker or an impostor who had placed in front of the end-user device another electronic device (e.g., an iPad or another tablet) which plays a video of the face of the genuine user; and this may trigger the system to reject or block the submitted transaction.

In a third example for ensuring liveness and freshness, some embodiments may perform post-processing or real-time processing for paper detection, to ensure that a malicious actor or an attacker did not try to spoof the user’s identify with a printed image of the user, such as, maliciously displaying to the end-user device a color printed image of the legitimate user. For example, a computer vision process may analyze the captured video, in order to specifically look for (and detect) paper imperfections, paper folds, paper wrinkles, paper shading, a two-dimensional or “flat” appearance of the image or face that is associated with a paper image and not with a three-dimensional head or object, or other paper revealing features that may thus be utilized for blocking or rejecting the submitted transaction.

In another example, some embodiments may perform post-processing or real-time processing for deep-fake detection, to ensure that a malicious actor or attacker did not try to spoof the user’s identify by generating a deep fake video image of the user using generative machine learning technology. For example, a deep-fake detection unit may search for, and may detect, imperfect transitions between: (i) frame-portions that are attributed to a first source (e.g., a photo or a video of the genuine user), and (ii) frame-portions that were added or modified by an attacker who created a deep-fake image or video; based on imperfect or abrupt “stitch lines” between image portions, or non-smooth or non-gradual transitions between two neighboring image-portions or frame-regions; or other techniques for detecting a deep fake image or video, which may then trigger a determination to block or reject a submitted transaction.

In yet another example, some embodiments may perform or may introduce one or more real-time liveliness or freshness challenges, in order to demonstrate active or “live” or “fresh” or current engagement of a human user with the application, and/or in order to detect various types of replay attacks or other spoofing attacks. Such challenges or tasks may be or may include, for example, a generating or displaying a message requiring the end-user to perform a particular gesture with his face and/or head and/or hand(s) (e.g., “please look to your right, and then look to your left”; or “please raise your right hand and make the letter V with your fingers”; or “please move your head to look down towards the ground and then look back up towards the camera”; or other suitable tasks or challenges, which may be pre-defined in a pool or bank or database of such tasks or challenges; and which may be selected from such database randomly or pseudo-randomly, or based on task selection rules or challenge selection rules that take into account the type of transaction that is being submitted, the monetary amount involved, and/or other parameters or data).

For demonstrative purposes, some portions of the discussion above were in the context of performing or submitting a financial transaction or a banking transaction or a monetary transaction; however, these were only non-limiting examples, and embodiments of the present invention may be utilized in conjunction with a variety of other types of operations, transactions, and systems; and some embodiments may be agnostic to the type of transaction being performed or to the context of the transaction. For example, some embodiments of the present invention may be utilized for, or in conjunction with: performing a transaction in a securities account or a brokerage account; performing a transaction in crypto-currency or digital currency; composing and/or sending an electronic mail (email) message or other type of electronic or digital message in a manner that verifies the sender and/or the message; inputting and/or sending confidential information or confidential data; inputting and/or sending medical data, by a patient and/or by a physician and/or by a pharmacy and/or by a health practitioner or other entity; inputting and/or sending a medical prescription or a medical record by a physician or health practitioner; entering of data into an online form, or into a multi-part form or a multi-page form, or into a set of forms, or into a set of on-screen fields; modification of existing data (e.g., changing of account information or user information); entering or creating or adding a signature onto a form or a document (e.g., into or onto a PDF document); typing and/or sending of messages, Instant Messaging (IM) items or messages, chat messages, real-time messages, email messages, or other messages or interactions; inputting and/or sending a legal document or a legally-operative data-item or document (e.g., an attorney or a notary public submitting or sending a verified signature on an affidavit or a sworn statement); transmission of insurance-related information or data; authoring and/or transmission of data or a data-item that is intended to be entered into a blockchain data-set or a blockchain data structure; and/or various other types of data entry, data composing or authoring, data submission, data transmission, transmission of messages and/or data-items, and/or the processing of such data-items in a manner that requires to authenticate the sender and/or to verify the transaction or its data.

For demonstrative purposes, some portions of the discussion may refer to operations of user authentication and/or transaction verification as performed on (or by, or via) a remote server or an external server; however, these are only non-limiting examples; some, or all, of such operations may be performed, in some implementations, exclusively in or by the end-user device itself, or via a collaboration between the end-user device and the remote server, or via other suitable scheme that distributes the processing operations among two or more devices or units, which may be local and/or remote.

In some embodiments, video is recorded and captured by the end-user device, while the user is entering data and/or performing a transaction; and different implementations may determine differently whether, or how, to display to the end-user the video that is being captured. In a first implementation, the video feed that is being captured by an imager or a camera of the end-user device (e.g., by a front-side camera of a smartphone or a tablet), is also displayed or shown in real time on the screen of the end-user device, such as, as a small rectangle (e.g., occupying between 10 percent to 50 percent of the screen size) that is located at a corner of the screen. In a second implementation, the video feed that is captured is not shown at all to the end-user on the end-user device; and the system may operate entirely without ever showing to the end-user the actual or the real time video feed that was captured. In a third implementation, the video feed is shown to the user only for a partial period of time, such as, during the first three seconds of commencing to capture the video feed, in order to ensure that the end-user understands that he is being imaged, and then the on-screen display of the video feed is turned off or is removed or concealed (e.g., in order to allow the user to engage with the full on-screen UI or GUI). In a fourth implementation, the screen or the display unit of the end-user device, may show a modified version or a manipulated version or an altered version of the video feed that is actually being imaged and captured; for example, a cropped version which keeps only the imaged face of the user and crops-out most of the background behind him, or a blurred or partially-blurred version of the captured video feed (e.g., keeping the human face area non-blurred, while blurring some or all of the background image portions). In a fifth implementation, the screen or display unit of the end-users device, may show an animated avatar or a virtual representation of the user or of his face, or an animated cartoon representation thereof, or a personalized Emoji character (e.g., similar to Bitmoji characters or avatars), or the like; which may optionally be animated randomly, or which may optionally be animated in accordance with the actual video being captured and/or in accordance with the actual audio being captured (e.g., the video capture indicates that the user is yawning, and the on-screen avatar is animated to be yawning).

Some embodiments may optionally utilize a passive challenge to confirm (or detect, or estimate) liveness of the end-user; in which the liveness of the user is tested in a passive manner which is transparent and/or unknown to the user, wherein the user is not aware that the system is testing or estimating the liveness property. For example, the user is utilizing his electronic device to enter and submit transaction data; the front-side camera of the electronic device is operational, to capture the video of the user; a live feed of the acquired video is displayed in real time at a rectangular picture-in-picture on the screen of the electronic device; then, the application on the end-user device may intentionally cause a zoom-in, or a zoom-out, or other zoom-related modifications, or other shifting of moving or modifications or an expansion or a shrinkage of the field-of-view of the camera of the electronic device, thereby causing the face of the end-user to be partially (or even entirely) out of the modified or zoomed field-of-view of the camera, or thereby causing the face of the user to not appear (entirely, or at least partially) in the live video feed being captured and displayed in real time; the legitimate human user who actually operates the end-user device (e.g., and not a remote attacker or a malware, and not an attacker performing a spoofing attack via a paper image or via a digital image or via a digital video or via a deep-fake image or a deep-fake video of the legitimate user) is expected to notice that his face is not (entirely, or partially) within the displayed feed, and is expected to move or shift the position or location of his body or of his head or of the electronic device in order to adequately show his face within the captured video feed; thereby inducing the legitimate user to perform such real-world modifications that correct the on-screen anomaly, and thus enabling the system to determine liveness of the current end-user. In contrast, lack of corrective actions in response to such a challenge, may cause the system to estimate that the current user is an attacker or a malware that lacks liveness. Other types of challenges may be used for liveness detection or verification.

Some embodiments may perform on-device (or in-device) data fusion or data entanglement, for privatization purposes and/or for other purposes. For example, the system may collect biometric data and action signals (e.g., transaction data that is entered by the user via his electronic device), and then fuses or merges this data into a single unified channel of data on the end-user device itself; for example, by passing the data through a non-reversible entanglement transformation or fusion transformation or hash function or hashing formula. This results in entangled data or fused data, such that an attempt to attack or manipulate the biometric data therein, would fundamentally corrupt the action data or the transaction data, and vice versa. Furthermore, the data entanglement process may also eliminate any human-identifiable biometric signatures from the unified data that is utilized for user authentication and transaction verification.

Some embodiments may utilize one or more ways or units, in order to combine or fuse together biometric data with transaction data. In addition to, or instead of, the ways and the units described above, one or more of the following method(s), may be used: (a) Using the microphone of the end-user device to listen to (or to monitor) the ambient audio while the user is entering transaction data, thereby capturing and detecting audio that indicates the existence of keyboard clicking and/or finger(s) clicking and tapping sounds, thus ensuring that a physical input was indeed present based on the audio sounds that it emitted, and ensuring that physical taps and keystrokes have indeed triggered a digital response on the end-user device (e.g., in contrast with a malware or a remote attacker). (b) Monitoring and recording of mouse movements and clicks and gestures, and/or gestures or interactions with a touch-pad or other physical input unit or tactile input unit of the electronic device; and adding such monitored data into the unified data channel that represents both biometric data and transaction data. (c) Utilization of Augmented Reality (AR) methods, to request the end-user to perform a task or to enter a code or a secret that the user knows; for example, to perform a particular pre-defined hand motion or hand gesture that was set in advance for this user, or performing spatial touching of (or, spatial gesturing or pointing towards or at) particular AR-based elements that are projected or otherwise viewable via an AR environment or an AR device (e.g., AR helmet or gear or glasses or other equipment), or performing other AR-based task or challenge which requires the end-user to perform certain spatial gestures which are imaged by the camera(s) of his end-user device and their existence and correctness are analyzed and verified based on a captured video or from an uploaded streaming video. (d) Utilization of interactive means for verifying a transaction, by requiring the user to perform a particular gesture or spatial gesture (e.g., randomly or pseudo-randomly selected from a pool or a bank of pre-defined gestures), for example, requiring the user to move his face or to nod his head or to blink with his eyes or to move his hands or fingers, as a way of confirming liveness and/or in order to indicate the user’s approval to confirm a transaction.

Embodiments of the present invention may thus operate to combine or merge or fuse together, (i) biometric data (or user interaction data) and (ii) transaction data or action data, into a unified data-item or a unified vector or channel of information; optionally utilizing or applying a privatization method or a fusion or hashing or data transformation method to facilitate this process. Embodiments of the present invention may both concurrently (i) authenticate the identity of the user, and (ii) validate or verify the submitted transaction, as (or using) a single unified verification step. Some embodiments may further provide continuous or substantially continuous authentication and verification of a transaction and the biometric data associated with it, throughout the course or the path of a transaction, and not just at an ending time-point at which the transaction data is submitted for processing.

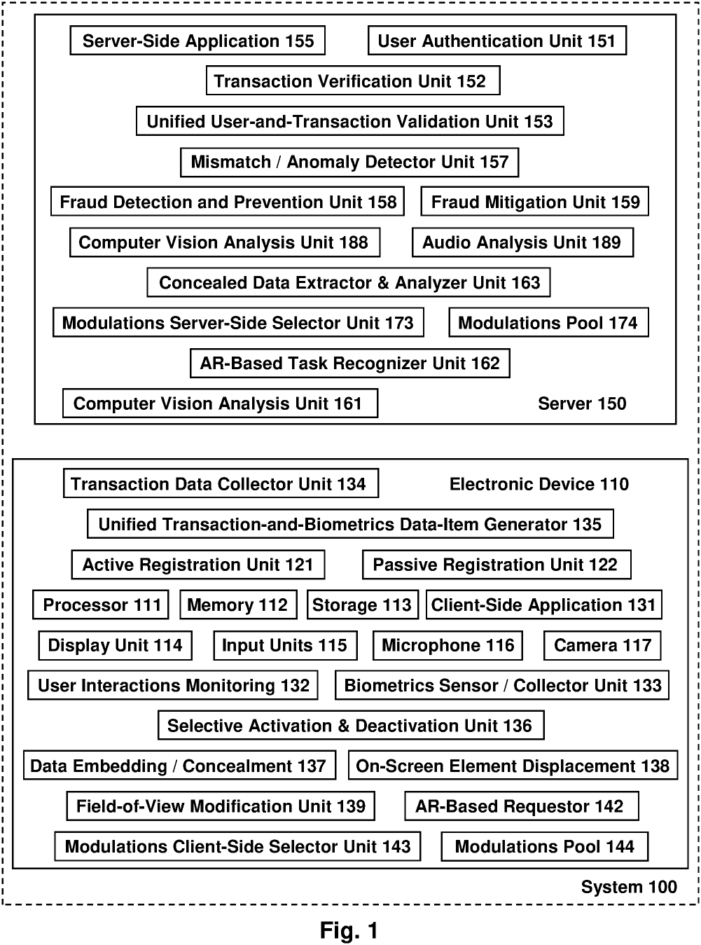

Reference is made to FIG. 1, which is a schematic block-diagram illustration of a system 100, in accordance with some embodiments of the present invention. System 100 may be implemented using a suitable combination of hardware components and/or software components.

For example, an Electronic Device 110 may be utilized by an end-user in order to interact with a computerized service, typically implemented as via a remote Server 150 (e.g., a dedicated server, a “cloud computing” server, an application server, a Web server, or the like). Electronic Device 110 may be, for example, a laptop computer, a desktop computer, a smartphone, a tablet, a smart-watch, a smart television, or the like. Electronic Device 110 may communicate with Server 150 via one or more wired and/or wireless communication links and/or networks; for example, over the Internet, via an Internet connection, via an Internet Protocol (IP) connection, via a TCP/IP connection, via HTTP or HTTPS communication, via Wi-Fi communication, via cellular communication (e.g., via 5G or 4G LTE or 4G or 3G or 2G cellular communication), or the like.

Electronic Device 110 may comprise, for example: a processor 111 able to execute code; a memory unit 112 (e.g., Random Access Memory (RAM) unit, Flash memory, volatile memory) able to store data short-term; a storage unit 113 (e.g., Hard Disk Drive (HDD), Solid State Drive (SSD), optical drive, Flash memory, non-volatile memory) able to store data long-term; a display unit 114 (e.g., a touch screen, or non-touch screen, or other display unit or monitor); one or more input units 115 (e.g., keyboard, physical keyboard, on-screen keyboard, touch-pad, touch-screen); a microphone 116 able to capture audio; a camera 117 or imager(s) (e.g., front-side camera, front-facing camera, rear-side camera, rear-facing camera) able to capture video and/or images; and/or other suitable components. Electronic Device 110 may further include, for example, a power source (e.g., battery, power cell, rechargeable battery) able to provide electric power to other components of Electronic Device 110; an Operating System (OS) with drivers and applications or “apps”; optionally, one or more accelerometers, one or more gyroscopes, one or more compass units, one or more spatial orientation sensors; and/or other components.

Electronic Device 110 may comprise a Client-Side Application 131, which enables the end-user to perform or to submit or to request a transaction, typically being in communication over wired and/or wireless communication link(s) with Remote Server 150. For example, Remote Server 150 may comprise a Server-Side Application 155 (e.g., a server-side banking application or online commerce application), which may include or may be associated with a User Authentication Unit 151 and a Transaction Verification Unit 152; and in some embodiments, they may be implemented as a Unified User-and-Transaction Validation Unit 153 as it may concurrently authenticate the user and verify transaction at the same time and based on the same unified channel of data which fuses together biometric data and transaction data.

The Server-Side Application 155 may perform any of the functionalities that are discussed above and/or herein with regard to server-side operations, by itself and/or by being operably associated with one or more server-side components and/or by being operably associated with one or more client-side components (which may optionally perform some of the operations or functionalities described above and/or herein). Similarly, the Client-Side Application 131 may perform any of the functionalities that are discussed above and/or herein with regard to client-side operations, by itself and/or by being operably associated with one or more client-side components and/or by being operably associated with one or more server-side components (which may optionally perform some of the operations or functionalities described above and/or herein). It is noted that FIG. 1 shows, for demonstrative purposes, some components as being located on the server side, and shows some other components as being located on the client side; however, this is only a non-limiting example; some embodiments may implement on the client side one or more of the components that are shown as located on the server side; some embodiments may implement on the server side one or more of the components that are shown as located on the client side; some embodiments may implement a particular component, or some component, by utilizing both a server-side unit and a client-side unit; or by using other suitable architectures. In some embodiments, raw data and/or partially-processed data and/or fully-processed data, as well as sensed data and/or measured data and/or collected data and/or newly-generated data, may be exchanged (e.g., over a secure communication link) between client-side unit(s) and server-side unit(s), or between the end-user device and the remote server, or between or among components that are located on the same side of the communication channel.

Optionally, biometric representation of a user may be created or generated actively via the Active Registration Unit 121; or, biometric representation of the user may be created or generated passively via the Passive Registration Unit 122. A Mismatch / Anomaly Detector Unit 157 may operate to detect an anomaly or a mismatch or discrepancy or corrupted data or manipulated data, in the unified data channel that comprises transaction data and biometrics data. A Fraud Estimation / Detection Unit 158 may detect or estimate or determine that the transaction is fraudulent and/or that the user is not the genuine legitimate user or that the unified data channel has been corrupted or manipulated or tampered with, based on the mismatch or anomaly detected, and/or based on other parameters involved or conditions checked, e.g., taking into account the type of transaction that was requested, such as a retail purchase or a wire transfer; taking into account the monetary amount or the monetary value of the transaction; taking into account one or more risk factors or fraud-related indicators that are pre-defined or that are detected (e.g., the transaction is performed from a new computing device that was never used before by this user or by this account owner, or from a geographic location or from an Internet Protocol (IP) address that was never used before by this user or by this account owner, or the like).

Fraud Detection and Prevention Unit 158 may perform one or more operations of fraud detection or fraud estimation or fraud determination, based on the anomalies or discrepancy or fraud-related signals that the system may be able to produce or generate. If it is estimated or determined that a fraudulent transaction is submitted, optionally with a fraud certainty level that is greater than a pre-defined threshold value, then Fraud Mitigation Unit 159 may trigger or may perform one or more fraud mitigation operations or fraud reduction operations; for example, by blocking or rejecting or freezing the submitted transaction or the associated account, by requiring the user to perform additional authentication operations via additional authentication device(s) or route(s) (e.g., two-factor authentication), by requiring the user to contact a customer service representative by phone or in person, by requiring the user to answer security questions, or the like.

Some embodiments of the present invention may include methods and systems for user authentication and/or transaction verification, or for a single-step validation or unified validation of user-and-transaction, or for fraud detection and fraud mitigation. For example, a computerized method may include: (a) monitoring interactions of a user who interacts with an electronic device to enter transaction data, and extracting one or more biometric traits of the user; (b) generating a unified data-item, that represents a unified fusion of both (i) the transaction data, and (ii) biometric data reflecting the one or more biometric traits of the user that were extracted from interactions of the user during entry of transaction data. The monitoring of user interactions may be performed by a User Interactions Monitoring Unit 132, which may monitor and/or log and/or track and/or record user interactions that are performed by the user. Optionally, a Biometrics Sensor / Collector Unit 133 may operate to collect and/or to generate biometric data, based on data or readings or measurements that are sensed or measured by one or more input units of the end-user device and/or by one or more sensors of the end-user device. Transaction Data Collector Unit 134 operates to collect the transaction data that is being entered or submitted, or that was entered and/or submitted, by the user. Unified Transaction-and-Biometrics Data-Item Generator 135 operates to fuse together, or merge, or otherwise unify, the biometrics data and the transaction data, or to embed or conceal one of them into the other, or to otherwise generate entanglement of the transaction data with the biometrics data. The unified transaction-and-biometrics data-item (or record) may then be transferred or transmitted to the remote server, via a secure communication channel, and may be processed there by the Unified User-and-Transaction Validation Unit 153.

In some embodiments, the transaction data within the unified data-item that is generated in step (b), cannot be modified or corrupted without also causing modification or corruption of the biometric data within the unified data-item; and similarly, the biometric data within the unified data-item that is generated in step (b), cannot be modified or corrupted without also causing modification or corruption of the transaction data within the unified data-item;

In some embodiments, modification or corruption of the transaction data within the unified data-item, automatically causes modification or corruption of the biometric data within the unified data-item; and similarly, modification or corruption of the biometric data within the unified data-item, automatically causes modification or corruption of the biometric data within the unified data-item.

In some embodiments, the method comprises: (A) during entry of transaction data by said user via the electronic device, activating a video camera of said electronic device and capturing a video feed of said user; (B) embedding at least part of the transaction data as digital data that is added into and is concealed within one or more video frames of said video feed; (C) authenticating said user and the submitted transaction, based on said video feed that includes therein the transaction data concealed within one or more video frames thereof.

In some embodiments, selective activation and/or de-activation of the video camera, and/or of other components of the end-user device that are discussed above and/or herein (e.g., the illumination unit or the “flash” illumination unit; the vibration unit, or other tactile feedback unit; the microphone; or the like) may be performed by a Selective Activation & Deactivation Unit 136; and such selective activation or deactivation may optionally be performed based on one or more commands or signals or triggers, which may be generated locally in the end-user device (e.g., the client-side application 131 may trigger a selective activation of the front-facing video camera, since the user is requesting to commence data entry for a wire transfer to a new payee), and/or which may be received from the remote server (e.g., the remote server 150 may send a command to the end-user device, requiring to activate the front-facing video camera of the end-user device, since it detects that the end-user device is connected to the remote server via a new IP address that was not seen before for this user). Other criteria or conditions may be used.

In some embodiments, the embedding operations or the concealing operations may be performed locally within the end-user device via an Data Embedding / Concealment Unit 137, which may utilize one or more steganography techniques, encoding, cryptographic algorithms, data fusion algorithms, data hashing algorithms, or other suitable methods.

In some embodiments, the method comprises: (A) during entry of transaction data by said user via the electronic device, activating a video camera of said electronic device and capturing a video feed of said user; (B) during the capturing of the video feed of the user during entry of the transaction data, causing said electronic device to vibrate (e.g., by activating its vibration unit, or other tactile feedback unit) at a particular time-point and in accordance with a pre-defined vibration scheme; (C) performing an analysis of captured video that was captured by the camera of the electronic device during entry of data of said transaction, to detect whether or not a content of the captured video reflects said pre-defined vibration scheme at said particular time-point.

In some embodiments, for example, a Computer Vision Analysis Unit 188 may receive the video from the end-user device, over a secure communication channel; and may perform analysis of the video in order to determine whether the content of the video indeed reflects the vibration(s) at the relevant time-points or time-slots (e.g., a rapid displacement of the content of a frame, sideways or right-and-left or up-and-down, generally in accordance with the vibration pattern or the vibration scheme that was introduced on the end-user device).

In some embodiments, the method comprises: (A) during entry of transaction data by said user via the electronic device, activating a microphone of said electronic device and capturing an audio feed; (B) during a capture of audio during entry of the transaction data, causing said electronic device to emit a particular audible sound at a particular time-point; (C) performing an analysis of captured audio that was captured by the microphone of the electronic device during entry of data of said transaction, to detect whether or not a content of the captured audio reflects said particular audible sound at said particular time-point.

In some embodiments, for example, an Audio Analysis Unit 189 may receive the audio from the end-user device, over a secure communication channel; and may perform analysis of the audio in order to determine whether the content of the audio indeed reflects the particular audible sounds that were introduced by the end-user device at the relevant time-points.

In some embodiments, the method comprises: (A) during entry of transaction data by said user via the electronic device, activating a video camera of said electronic device and capturing a video feed of said user; (B) during the capturing of the video feed of the user during entry of the transaction data, causing at a particular time-point a particular displacement of an on-screen element within a screen of the electronic device, wherein said displacement of the on-screen element is intended to induce a particular change in a staring direction or a gazing direction of the user (e.g., by an On-Screen Element Displacement Unit 138, which may displace or move an on-screen element, or which may animate an on-screen element in a manner that is expected to attract attention or staring or gazing by the end-user; or which may add or modify visual attributes to an on-screen element, such as, by repeatedly changing its color or its brightness level or its size); and then (C) performing an analysis of captured video that was captured by the camera of the electronic device during entry of data of said transaction, to detect whether or not a content of the captured video reflects at said particular time-point said particular change in the staring direction or the gazing direction.

In some embodiments, the method comprises: (A) during entry of transaction data by said user via the electronic device, activating a video camera of said electronic device and capturing a video feed of said user; (B) during the capturing of the video feed of the user during entry of the transaction data, causing a zoom-related operation of the camera to change the field-of-view of the camera that is captured in said video field (e.g., performed by a Field-of-View Modification Unit 139), and thus causing a face of the user to be at least partially outside of the field-of-view of the camera; (C) performing an analysis of captured video that was captured by the camera of the electronic device during entry of data of said transaction, to detect whether or not a content of the captured video reflects a corrective physical action that said user performed to bring his face fully into the field-of-view of the camera of the electronic device.

In some embodiments, the method comprises: (A) during entry of transaction data by said user via the electronic device, activating a video camera of said electronic device and capturing a video feed of said user; (B) during the capturing of the video feed of the user during entry of the transaction data, generating a notification requiring the user to perform a particular spatial gesture with a particular body part of the user; (C) performing an analysis of captured video that was captured by the camera of the electronic device during entry of data of said transaction, to detect whether or not a content of the captured video reflects the particular spatial gesture of the particular body part. The client-side operations may be performed via a Spatial Gesture(s) Requestor Unit 141, which may select or generate the request to perform the particular spatial gesture. The server-side operations may be performed via the Computer Vision Analysis Unit 188, or by a Spatial Gesture Recognizer Unit 161 or other component(s).

In some embodiments, the method comprises: (A) during entry of transaction data by said user via the electronic device, activating an Augmented Reality (AR) component that is associated with the electronic device; (B) generating a notification requiring the user to perform a particular spatial gesture to interact with a particular AR-based element that is displayed to the user via said AR component; (C) performing an analysis of captured video that was captured by a camera of the electronic device during entry of data of said transaction, to detect whether or not a content of the captured video reflects said particular spatial gesture. The client-side operations may be performed via an AR-Based Requestor Unit 142, which may select or generate the request to perform the AR-based gesture(s) or task(s). The server-side operations may be performed via the Computer Vision Analysis Unit 188, or by an AR-Based Task Recognizer Unit 162 or other component(s).

In some embodiments, the method comprises: (A) during entry of transaction data by said user via the electronic device, activating a video camera of said electronic device and capturing a video feed of said user; (B) during the capturing of the video feed of the user during entry of the transaction data, causing an illumination unit of said electronic device to illuminate at a particular time-point and in accordance with a pre-defined illumination scheme; (C) performing an analysis of captured video that was captured by the camera of the electronic device during entry of data of said transaction, via the Computer Vision Analysis Unit 161, to detect whether or not a content of the captured video reflects said pre-defined illumination scheme at said particular time-point.

In some embodiments, the method comprises: (A) during entry of transaction data by said user via the electronic device, activating a microphone of said electronic device and capturing an audio feed; (B) performing an analysis of captured audio that was captured by the microphone of the electronic device during entry of data of said transaction, via the Audio Analysis Unit 189, to detect whether or not said captured audio reflects sounds of physical keystrokes and sounds of physical taps that match data entry of the transaction data that was submitted via said electronic device.

In some embodiments, step (b) that was mentioned above may comprise: embedding and concealing said transaction data, into one or more video frames of a video that is captured by the electronic device during entry of transaction data. This may be performed by the Data Embedding / Concealment Unit 137. The embedded data or the concealed data may then be extracted and processed on the server side for user authentication and transaction verification, by a Concealed Data Extractor & Analyzer Unit 163.

In some embodiments, step (b) that was mentioned above may comprise: generating the unified data-item by performing digital hashing, in accordance with a pre-defined digital hash function, of said transaction data and said biometric data; or by performing other suitable process of unidirectional privatization of the data, or a process of privatization transformation of the data, which passes the data through a one-way transformation that is non-reversible; wherein the original (pre-transformation) data cannot be reversed or obtained from the post-transformation data; wherein the post-transformation data is sufficient for the purposes of biometric analysis and/or user authentication and/or transaction verification.

In some embodiments, step (b) that was mentioned above may comprise: performing continuous real-time authentication of the user during entry of transaction data, and concurrently performing real-time verification of the transaction data; wherein said performing is a single step process of concurrent user authentication and transaction verification; wherein said single step process lacks a time-gap between user authentication at log-in and transaction verification at transaction submission.

In some embodiments, step (b) that was mentioned above may comprise: embedding and concealing, into one or more video frames of a video that is captured by the electronic device during entry of transaction data, at least one of: (I) a name of a recipient or a beneficiary of the transaction, (II) an address of a recipient or a beneficiary of the transaction, (III) a monetary amount of the transaction.

In some embodiments, the method comprises: (A) during entry of transaction data by said user via the electronic device, activating a video camera of said electronic device and capturing a video feed of said user, and also, activating a microphone of said electronic device and capturing an audio feed of said user; (B) during the capturing of the video feed and the audio feed, causing the electronic device to perform at a particular time-slot, at least one modulation that is selected from the group consisting of: (I) a visual modulation that affects video captured by the camera, (II) an audible modulation that affects audio captured by the microphone; (C) performing an analysis of captured video and captured audio, that were captured by the electronic device during entry of data of said transaction, to detect whether or not the captured video and the captured audio reflect, at said particular time-slot, said at least one modulation.

The particular modulation(s) that are performed may be selected locally in the end-user device 110; or may be selected remotely at the remote server 150 and then conveyed as signals indicating to the end-user device 110 which modulation(s) are required to be performed; or may be a combination or an aggregation of locally-selected modulations and remotely-commanded modulations. For example, a Modulations Client-Side Selector Unit 143 may select one or more modulations to apply, from a locally-stored Modulations Pool 144, based on one or more pre-defined triggers or conditions or criteria (e.g., the electronic device 110 detects that the user is commencing a process to perform a wire transfer to a new payee); and/or, a Modulations Server-Side Selector Unit 173 may select one or more modulations that the electronic device 110 should apply, from a remotely-stored Modulations Pool 174, based on one or more pre-defined triggers or conditions or criteria (e.g., the remote server detects that the electronic device is logged-in from an IP address or from a geo-location that was not associated in the past with this particular electronic device). In some embodiments, the particular modulation that is selected to be applied, or the particular set or group of modulations that is selected to be applied, may be selected by taking into account, for example, the type of the transaction being submitted or entered (e.g., selecting an illumination modulation for a wire transfer transaction, or selecting an audio modulation for an online retail purchase transaction), and/or based on the monetary amount involved in the transaction (e.g., selecting an illumination modulation for a wire transfer having a monetary amount that is greater than $750, or selecting an audio modulation for a wire transfer having a monetary amount that is equal to or smaller than $750), and/or based on the geographic region or the geo-location of the current end-user or of the recipient (e.g., if geo-location of the current user indicates that he is located within the United States then apply illumination modulation; if geo-location of the current user indicates that he is located within Russia then apply audio modulation), and/or based on the geographic region or the geo-location of the recipient or beneficiary (e.g., if the beneficiary address is within the United States then apply an illumination modulation; if the beneficiary address is within China then apply an audio modulation), and/or based on the current time-of-date or day-of week (e.g., avoiding an audio modulation if the local time at the end-user device is estimated to be 3 AM; or conversely, in some implementations, select an audio modulation during night-time at the end-user device), and/or based on other parameters or conditions. In some embodiments, two or more modulations may be selected and applied in series, within the same video capture or audio capture or image(s) capture process, and within the same single transaction that is being submitted or entered; for example, User Adam performs a wire transfer transaction which takes him 45 seconds; during the first quarter of the transaction, an illumination modulation is performed; during the third quarter of the same transaction, an audio modulation is performed; during the last quarter of the same transaction, a device vibration modulation is performed. In some embodiments, two or more modulations may be selected and applied in parallel or concurrently or simultaneously, or in two time-slots that are at least partially overlapping with each other, within the same video capture or audio capture or image(s) capture process, and within the same single transaction that is being submitted or entered; for example, User Bob performs a wire transfer transaction which takes him 60 seconds; during the second quarter of the transaction, an illumination modulation is performed for 3 seconds, and in parallel, a device vibration modulation is performed for 2 seconds. In some embodiments, the modulation(s) are selected exclusively on the client side, on the end-user device; in other embodiments, the modulation(s) are selected exclusively on the server side, such as, on the server that runs the application that processes the transaction (e.g., a server-side banking application that runs on a server of a bank; a server-side securities trading application that runs on a server of a securities trading firm; an e-commerce server-side application that runs on a server of an online merchant; a trusted server or a fraud-detection server that is run or administered by a trusted third-party that provides security-related services to banks or retailers or other entities); in still other embodiments, the modulation(s) are selected by cooperation between the client-side device and the remote server; in yet other embodiments, one or more modulations are selected locally by the end-user device, and one or more additional modulations are selected remotely by the remote server. Other suitable modulation schemes may be used.

Although portions of the discussion herein relate, for demonstrative purposes, to wired links and/or wired communications, some embodiments are not limited in this regard, but rather, may utilize wired communication and/or wireless communication; may include one or more wired and/or wireless links; may utilize one or more components of wired communication and/or wireless communication; and/or may utilize one or more methods or protocols or standards of wireless communication.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may thus comprise any possible or suitable combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some demonstrative embodiments of the present invention have been illustrated and described herein, various modifications, substitutions, changes, and equivalents may occur to those skilled in the art. Accordingly, the claims are intended to cover all such modifications, substitutions, changes, and equivalents.

What is claimed is:

1. A method for authenticating identity of a user of an electronic device and for verifying a authenticity of a transaction that the user submits via the electronic device, the method comprising:
(a) while the user interacts with one or more input units of the electronic device to enter transaction data into a computerized system,
capturing video of said user via a front-side camera of said electronic device;
(b) while the user interacts with said one or more input units of the electronic device to enter said transaction data into said computerized system,
generating at said electronic device an interfering device-based event, that is selected from the group consisting of:
(b1) causing said electronic device to vibrate at a particular vibration pattern having a particular vibration timing and a particular vibration sequence,
(b2) causing said electronic device to generate a particular audio noise pattern in accordance with a pre-defined particular audio noise timing and a particular audio noise sequence,
(b3) causing said electronic device to activate an illumination unit of said electronic device in accordance with a particular illumination pattern having a particular illumination timing and a particular illumination sequence,
(b4) causing said electronic device to illuminate at least a portion of a screen of said electronic device in accordance with a particular screen illumination pattern having a particular screen illumination timing and a particular screen illumination sequence,
(b5) causing said electronic device to illuminate at least a portion of the screen of said electronic device in accordance with a particular color scheme having a particular colorization timing and a particular colorization sequence;
(c) performing a particular analysis of video content, that was captured while the user interacted with one or more input units of said electronic device to enter transaction data,
wherein said particular analysis checks whether or not the captured video content correctly reflects said interfering device-based event;
(d) if said particular analysis indicates that the captured video content does not correctly reflect said interfering device-based event, then: determining that transaction data that was submitted from said electronic device is fraudulent or was compromised.

2. The method of claim 1,
wherein generating at said electronic device an interfering device-based event,
comprises at least:
causing said electronic device to vibrate at a particular vibration pattern having a particular vibration timing and a particular vibration sequence.

3. The method of claim 1,
wherein generating at said electronic device an interfering device-based event,
comprises at least:
causing said electronic device to generate a particular audio noise pattern in accordance with a pre-defined particular audio noise timing and a particular audio noise sequence.

4. The method of claim 1,
wherein generating at said electronic device an interfering device-based event,
comprises at least:
causing said electronic device to activate an illumination unit of said electronic device in accordance with a particular illumination pattern having a particular illumination timing and a particular illumination sequence.

5. The method of claim 1,
wherein generating at said electronic device an interfering device-based event,
comprises at least:
causing said electronic device to illuminate at least a portion of a screen of said electronic device in accordance with a particular screen illumination pattern having a particular screen illumination timing and a particular screen illumination sequence.

6. The method of claim 1,
wherein generating at said electronic device an interfering device-based event,
comprises at least:
causing said electronic device to illuminate at least a portion of the screen of said electronic device in accordance with a particular color scheme having a particular colorization timing and a particular colorization sequence.

7. The method of claim 1, further comprising:
ensuring liveness and freshness of the captured video content, and detecting a possible replay attack, by displaying on the screen of the electronic device real-time captured video from the front-side camera and a particular frame that continuously moves in accordance with a pre-defined movement scheme, and requiring the user to move his body to cause his face to continuously be shown inside said particular frame.

8. The method of claim 1, further comprising:
ensuring liveness and freshness of the captured video content, and detecting a possible replay attack, by displaying on the screen of the electronic device a particular on-screen content-item that moves in accordance with a pre-defined movement scheme, and performing computer vision analysis of the captured video content to determine whether or not an eye gaze of the user moves and follows movement of the particular on-screen content-item.

9. The method of claim 1, further comprising:
ensuring liveness and freshness of the captured video content, and detecting a possible replay attack, by performing computer vision analysis of the captured video content; and determining whether the captured video content depicts, in addition to a human face, also a physical frame of a screen of an electronic tablet; and if yes, then determining that an attacker is replaying an image or a video of a legitimate user by holding an electronic tablet in front of the front-side camera of said electronic device.

10. The method of claim 1, further comprising:
ensuring liveness and freshness of the captured video content, and detecting a possible replay attack,
by performing computer vision analysis of the captured video content; and determining whether the captured video content depicts, in addition to a human face, also a physical frame of a screen of an electronic apparatus; and if yes, then determining that an attacker is replaying an image or a video of a legitimate user by holding an electronic apparatus in front of the front-side camera of said electronic device.

11. The method of claim 1, further comprising:
ensuring liveness and freshness of the captured video content, and detecting a possible fraudulent attack, by performing computer vision analysis of the captured video content;
and determining whether the captured video content depicts, in addition to a human face, also a one or more of: paper imperfections, paper folds, paper wrinkles, paper shading;
and if yes, then determining that an attacker is presenting to the front-side camera of the electronic device a paper having a printed image of a human face.

12. The method of claim 1, further comprising:
ensuring liveness and freshness of the captured video content, and detecting a possible replay attack that utilizes a deep-fake image or a deep-fake video,
by performing computer vision analysis of the captured video content,
and detecting imperfect transitions and abrupt stitch lines between: (i) frame-portions that are attributed to a first source which is a human face or a human body, and (ii) frame-portions that were added or modified by an attacker who created said deep-fake image or said deep-fake video.

13. The method of claim 1, further comprising:
ensuring liveness and freshness of the captured video content, and detecting a possible replay attack, by performing:
while the user is entering transaction data via said electronic device:
(I) displaying on the screen of the electronic device a real-time video feed from the front-side camera of the electronic device;
(II) causing the front-side camera to perform a zoom-in operation that causes a face of the user to be at least partially outside a field-of-view captured by the front-side camera;
(III) performing computer vision analysis of the captured video content, and determining whether or not the captured video content depicts a body movement of the user which attempts to bring his face into the field-of-view captured by the front-side camera.

14. The method of claim 1, further comprising:
capturing audio via a microphone of the electronic device, while the user is entering transaction data via said electronic device;
performing analysis of captured audio, and determining whether or not the captured audio reflects keystroke clicks that match keyboard-typed transaction data.

15. The method of claim 1, wherein the method comprises:
generating a recorded video segment, that includes in it: (i) continuous video that was captured by the front-side camera of the electronic device while the user was entering transaction data, and (ii) a modulation of video content or audio content, that was generated by said electronic device in accordance with a particular timing sequence and pattern while the user was entering transaction data.

16. The method of claim 1, wherein the method comprises:
generating a recorded video segment, that includes in it continuous video that was captured by the front-side camera of the electronic device while the user was entering transaction data;
encoding transaction data, into at least one frame of said recorded video segment.

17. The method of claim 1, wherein the method comprises:
streaming the captured video content from said electronic device over a communication link to a remote server, which performs said particular analysis of step (c) that checks whether or not the captured video content correctly reflects said interfering device-based event.

18. The method of claim 1, wherein the method comprises:
streaming only every Nth video frame of the captured video content, from said electronic device over a communication link to a remote server, which performs said particular analysis of step (c) that checks whether or not the captured video content correctly reflects said interfering device-based event; wherein N is a pre-defined integer.

19. The method of claim 1, wherein the method comprises:
performing step (a) and step (b) and step (c) and step (d) exclusively locally at said electronic device and without transmitting any video content to any remote server.

20. A system comprising:
one or more hardware processors that are configured to execute code;
operably associated with one or more memory units that are configured to store code;
wherein the one or more hardware processors are configured to perform a process for authenticating identity of a user of an electronic device and for verifying a authenticity of a transaction that the user submits via the electronic device,
the process comprising:
(a) while the user interacts with one or more input units of the electronic device to enter transaction data into a computerized system,
capturing video of said user via a front-side camera of said electronic device;
(b) while the user interacts with said one or more input units of the electronic device to enter said transaction data into said computerized system,
generating at said electronic device an interfering device-based event, that is selected from the group consisting of:
(b1) causing said electronic device to vibrate at a particular vibration pattern having a particular vibration timing and a particular vibration sequence,
(b2) causing said electronic device to generate a particular audio noise pattern in accordance with a pre-defined particular audio noise timing and a particular audio noise sequence,
(b3) causing said electronic device to activate an illumination unit of said electronic device in accordance with a particular illumination pattern having a particular illumination timing and a particular illumination sequence,
(b4) causing said electronic device to illuminate at least a portion of a screen of said electronic device in accordance with a particular screen illumination pattern having a particular screen illumination timing and a particular screen illumination sequence,
(b5) causing said electronic device to illuminate at least a portion of the screen of said electronic device in accordance with a particular color scheme having a particular colorization timing and a particular colorization sequence;
(c) performing a particular analysis of video content, that was captured while the user interacted with one or more input units of said electronic device to enter transaction data,
wherein said particular analysis checks whether or not the captured video content correctly reflects said interfering device-based event;
(d) if said particular analysis indicates that the captured video content does not correctly reflect said interfering device-based event, then: determining that transaction data that was submitted from said electronic device is fraudulent or was compromised.
